(19) United States
(12) Patent Application Publication
(10) Pub. No.: US 2025/0110538 A1
(43) Pub. Date: Apr. 3, 2025

(54) GRANULAR POWER GATING OVERRIDE

(71) Applicant: Advanced Micro Devices, Inc., Santa Clara, CA (US)

(72) Inventors: Meeta Surendramohan Srivastav, Austin, TX (US); Indrani Paul, Austin, TX (US); Akila Subramaniam, Austin, TX (US)

(73) Assignee: Advanced Micro Devices, Inc., Santa Clara, CA (US)

(21) Appl. No.: 18/477,458

(22) Filed: Sep. 28, 2023

(51) Int. Cl. G06F 1/3203

(52) U.S. Cl. CPC G06F 1/3203

(57) ABSTRACT

The disclosed device includes a processing component having various compute blocks, and a control circuit that switches at least one of the compute blocks from a normal voltage rail for the processing component to a second voltage rail in response to power gating a normal voltage rail. Various other methods, systems, and computer-readable media are also disclosed.

### BACKGROUND

Certain processing components, such as an inference engine, are a collection of individual compute blocks, such as an inference processing unit (IPU) or inference accelerator, a microprocessor for the IPU, memory management unit (MMU), etc. that operate collectively. For instance, the microprocessor can have its own static random access memory (SRAM) for storing inference weights used by the IPU. When power gating the inference engine, for example to put the inference engine into a low power state, the compute blocks are collectively power gated, which requires each power block to power down. However, certain compute blocks, such as the microprocessor, can incur significant latency to power down and later power back up (e.g., due to context save/restore operations for inference weights stored in the SRAM).

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for granular power gating override.

FIG. 2 is a block diagram of an exemplary architecture for granular power gating override.

FIG. 3 is a flow diagram of an exemplary method for granular power gating override.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to granular power gating override. As will be explained in greater detail below, implementations of the present disclosure switch a compute block of a processing component from a first voltage rail to a second voltage rail in response to power gating the first voltage rail to the processing component. The second voltage rail allows the compute block to at least be minimally powered on while the processing component is power gated, to avoid latency from low power entry/exit for the compute block, which in some examples can be the most significant source of low power entry/exit latency for the processing component. This granular power gating override also advantageously allows the processing component to meet entry/exit latency timing requirements for lower power states than would be available without the granular power gating override.

In one implementation, a device for granular power gating override includes a processing component comprising a plurality of compute blocks and configured to operation at a first voltage rail, and a control circuit configured to, in response to power gating the processing component by power gating the first voltage rail to the processing component, switch at least one of the plurality of compute blocks from the first voltage rail to a second voltage rail.

In some examples, the control circuit corresponds to a power multiplexer coupled to the at least one of the plurality of compute blocks and configured to switch the at least one of the plurality of compute blocks between the first voltage rail and the second voltage rail. In some examples, switching the at least one of the plurality of compute blocks from the first voltage rail to the second voltage rail allows the at least one of the plurality of compute blocks to remain powered on while the processing component is power gated. In some examples, power gating the processing component corresponds to entering a low power state.

In some examples, the at least one of the plurality of compute blocks corresponds to a microcontroller having one or more registers storing one or more values for a register context and power gating the processing component includes low power entry operations for the plurality of compute blocks. In some examples, switching the at least one of the plurality of compute blocks from the first voltage rail to the second voltage rail provides power to the microcontroller while the processing component is power gated such that the low power entry operations do not include a register context save operation for the microcontroller.

In some examples, the processing component corresponds to an inference engine, the at least one of the plurality of compute blocks corresponds to a microprocessor configured to store inference weights, and power gating the processing component includes low power entry operations for the plurality of compute blocks. In some examples, switching the at least one of the plurality of compute blocks from the first voltage rail to the second voltage rail provides power to the microprocessor while the processing component is power gated such that the low power entry operations do not include a context save operation of the inference weights for the microprocessor.

In some examples, the at least one of the plurality of compute blocks corresponds to a memory device. In some examples, the processing component corresponds to a graphics engine having the memory device.

In one implementation, a system for granular power gating override includes a first voltage rail, a second voltage rail, a processing component comprising a plurality of compute blocks and configured to operate at the first voltage rail, a power gater configured to couple the first voltage rail to the processing component, and a power multiplexer coupled between the power gater and a compute block of the plurality of compute blocks and configured to switch the compute block between the first voltage rail and the second voltage rail. The system also includes a control circuit configured to, in response to power gating the processing component by power gating the first voltage rail to the processing component, switch the compute block from the first voltage rail to the second voltage rail using the power multiplexer.

In some examples, the second voltage rail remains on during low power states of the system. In some examples, power gating the processing component corresponds to entering a low power state and switching the compute block from the first voltage rail to the second voltage rail allows the compute block to remain powered on during the low power state.

In some examples, the compute block corresponds to a microcontroller having a register storing a value for a register context. In some examples, entering the low power state includes low power entry operations for the plurality of compute blocks and switching the compute block from the first voltage rail to the second voltage rail provides power to the microcontroller during the low power state such that the low power entry operations do not include a register context save operation for the microcontroller.

In some examples, the processing component corresponds to an inference engine and the compute block corresponds to a microprocessor configured to store inference weights. In some examples, entering the low power state includes low power entry operations for the plurality of compute blocks and switching the compute block from the first voltage rail to the second voltage rail provides power to the microprocessor during the low power state such that the low power entry operations do not include a context save operation of the inference weights for the microprocessor.

In some examples, the at least one of the plurality of compute blocks corresponds to a memory device. In some examples, the processing component corresponds to a graphics engine having the memory device.

In one implementation, a method for granular power gating override includes (i) entering a low power state for a processing component comprising a plurality of compute blocks, (ii) in response to entering the low power state, switching a compute block of the plurality of compute blocks from a first voltage rail that is power gated for the low power state to a second voltage rail, and (iii) maintaining power to the compute block during the low power state.

In some examples, maintaining power to the compute block avoids a context save operation for the compute block when entering the low power state. In some examples, entering the low power state includes low power entry operations for the plurality of compute blocks, and the low power entry operations do not include low power entry operations for the compute block. In some examples, the method further includes (iv) exiting the low power state for the processing component, and (v) in response to exiting the low power state, switching the compute block from the second voltage rail to the first voltage rail.

Features from any of the implementations described herein can be used in combination with one another in accordance with the general principles described herein. These and other implementations, features, and advantages will be more fully understood upon reading the following detailed description in conjunction with the accompanying drawings and claims.

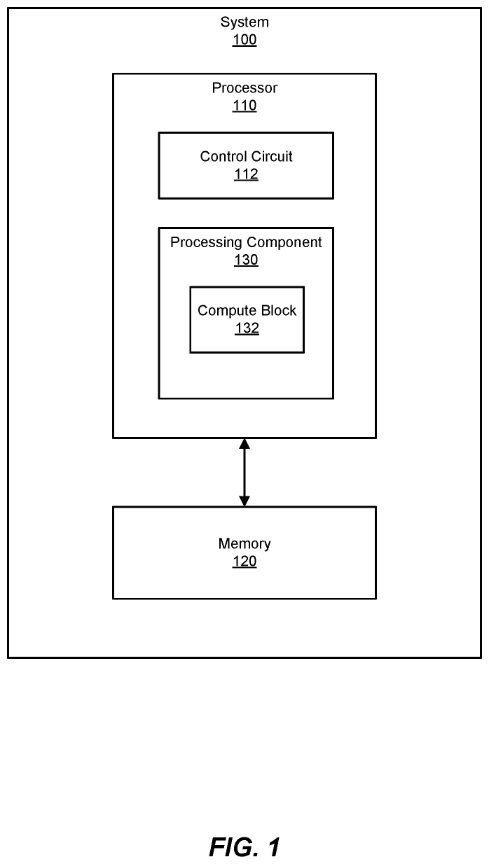

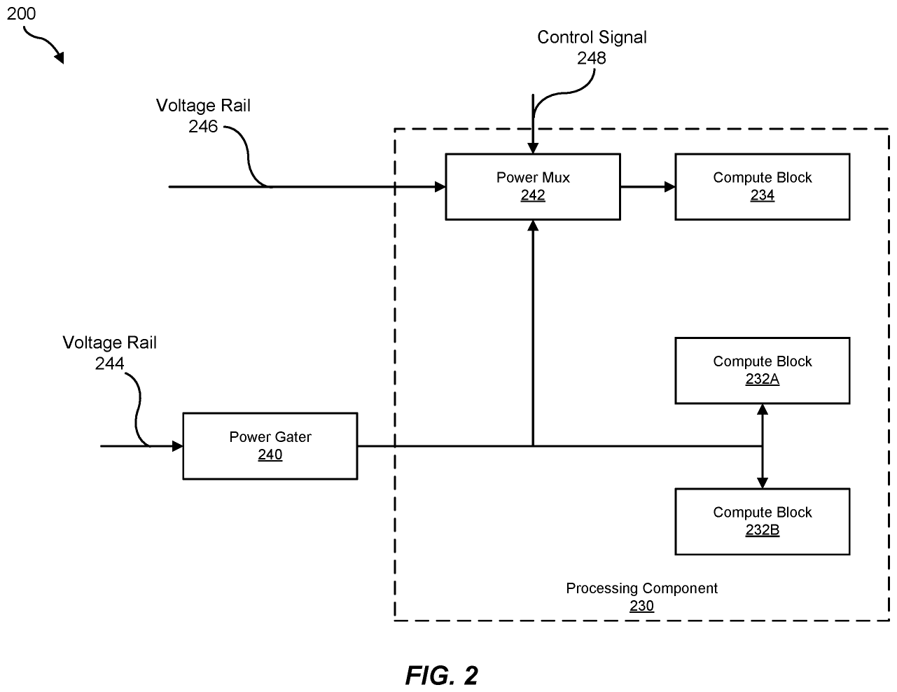

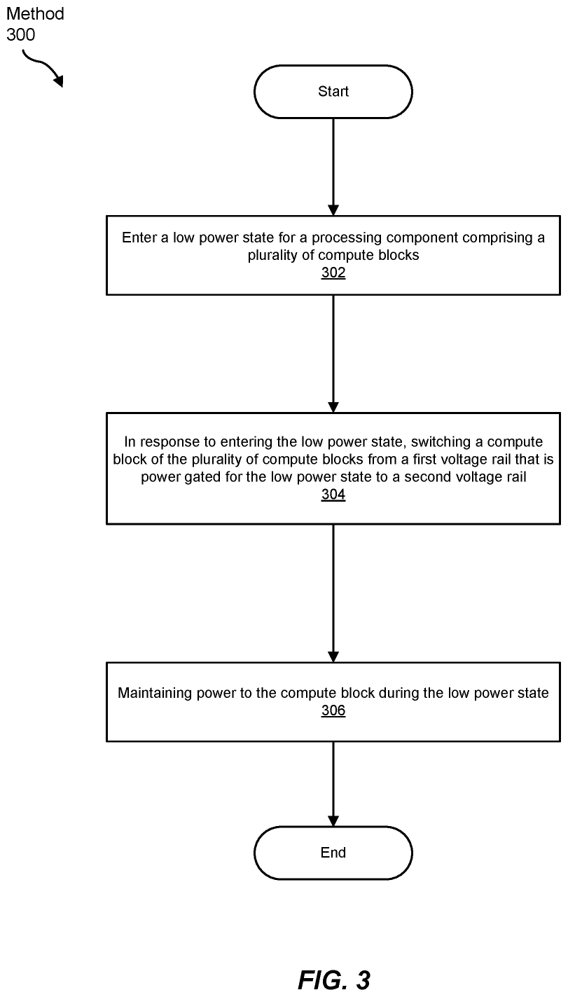

The following will provide, with reference to FIGS. 1-3, detailed descriptions of granular power gating override. Detailed descriptions of example systems will be provided in connection with FIGS. 1 and 2. Detailed descriptions of corresponding methods will also be provided in connection with FIG. 3.

FIG. 1 is a block diagram of an example system 100 for granular power gating override. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112, and a processing component 130, which further includes a compute block 132. Control circuit 112 corresponds to circuitry and/or instructions for power management control (e.g., for performing at least certain aspects of power management, such as monitoring for and/or coordinating entry/exit conditions of power states) and in some examples can include and/or interface with a power management controller/circuit, as well as power delivery circuits such as voltage regulators, power gaters, power multiplexers, etc. Processing component 130 corresponds to circuit or integrated circuit which in some examples can be any component of processor 110 and/or system 100 that can be a collection of various compute blocks, such as compute block 132. Processing component 130 can, in some examples, be a component of processor 110 capable of processing data and further can be a specialized processor. In some examples, processing component 130 can correspond to a processor such as an engine, a co-processor, etc. Although FIG. 1 illustrates processing component 130 as a component of processor 110, in some implementations processing component 130 can be separate from processor 110 and further in other implementations, processing component 130 can refer to processor 110. Compute block 132 corresponds to a circuit or integrated circuit that is a sub-component of processing component 130 that can coordinate with other iterations of compute block 132 to perform functions of processing component 130. In some examples, compute block 132 can correspond to one or more of a logic unit, a memory unit, an engine, a co-processor, etc. For instance, in some implementations processing component 130 can collectively correspond to multiple different iterations of compute block 132 that can be collectively managed with respect to power. More specifically, in some examples, processing component 130 can be configured for a supply voltage such that compute block 132 can also be configured for the supply voltage.

In some examples, control circuit 112 can manage aspects of power management of processing component 130 (and one or more iterations of compute block 132 collectively). For example, control circuit 112 can initiate or detect initiation of (e.g., via a power management signal) entry of a low power state for processing component 130. In some examples, control circuit 112 can also power gate or coordinate power gating processing component 130 for entering the low power state.

In some implementations, system 100 can support multiple low power states, such that lower power states can include successively more components/features being disabled and/or powered off. Each low power state can define entry/exit latency time requirements that ensure that transitioning between power states does not negatively affect performance and/or user experience (e.g., by having interdependent components having to significantly wait). In some examples, compute block 132 can incur low power entry/exit latency times that does not meet the requirements of certain low power states for processing component 130. As described herein, the low power entry/exit latency times can be avoided, allowing the certain low power states for processing component 130.

FIG. 2 illustrates a system 200 corresponding to system 100. System 200 includes a processing component 230 that corresponds to processing component 130. Processing component 230 includes a compute block 232A, a compute block 232B, and a compute block 234, each corresponding to different iterations of compute block 132. FIG. 2 also includes a power gater 240, a power mux 242, a voltage rail 244, a voltage rail 246, and a control signal 248.

Voltage rail 244 corresponds to a power signal for powering processing component 230. Power gater 240 corresponds to a circuit, such as a voltage regulator, for power gating, for example by enabling/disabling a power signal (e.g., voltage rail 244). Voltage rail 244 can provide power, through power gater 240, to processing component 230 and in some examples corresponds to a power signal used for powering a processor/SOC of system 200.

As illustrated in FIG. 2, voltage rail 244 is propagated (via power gater 240) to compute block 232A, compute block 232B, and (via power mux 242) compute block 234. Thus, when processing component 230 is power gated, voltage rail 244 is power gated for at least compute block 232A and compute block 232B. However, power mux 242, which corresponds to a power multiplexer or other circuit that can select from at least two input power signals as an output power signal, is coupled between power gater 240 and compute block 234. Power mux 242 is further coupled to voltage rail 246.

In some examples, voltage rail 246 corresponds to a second voltage rail that is independent from voltage rail 244. For instance, voltage rail 246 can correspond to a lower power voltage rail that in some examples is not power gated when processing component 230 and/or system 200 is in a low power state. In some examples, voltage rail 246 can correspond to a power signal for components that remain powered during low power states. In some implementations, control signal 248 (which in some examples is from a power management circuit such as control circuit 112) can indicate that processing component 230 and/or system 200 is entering a low power state or will otherwise be power gated. Power mux 242 can, in response to control signal 248, switch compute block 234 from voltage rail 244 to voltage rail 246, allowing compute block 234 to remain powered on (e.g., prevented from being power gated) while processing component 230 (e.g., compute block 232A and compute block 232B) enter the low power state (e.g., power gated). In some examples, control signal 248 can be a same or similar signal as sent by a power management controller for entering/exiting low power states.

Voltage rail 246 can provide sufficient power for compute block 234 to be at least minimally powered on (e.g., to avoid entering a low power state and more specifically, avoid incurring a latency for low power entry/exit). For instance, processing component 230 (e.g., compute block 232A and/or compute block 232B) can be instructed (e.g., by the power management circuit) to perform low power state entry operations in preparation for being power gated (and similarly compute block 232A and/or compute block 232B can be instructed to perform low power state exit operations when power gating ends). Compute block 234 can remain powered on to avoid low power state entry operations when processing component 230 is otherwise entering the low power state (and similarly compute block 234 can avoid low power state exit operations when processing component 230 is otherwise exiting the low power state). In some implementations, compute block 234 can receive no instructions to enter/exit the low power state while the rest of processing component 230 (e.g., compute block 232A and/or compute block 232B) receives instructions to enter/exit the low power state, although in other implementations compute block 234 can be actively instructed to avoid entering/exiting the low power state and/or ignore low power entry/exit instructions. In other words, low power entry/exit operations for processing component 230 can include low power entry/exit operations for compute block 232A and/or compute block 232B but does not include low power entry/exit operations for compute block 234.

In some examples, compute block 234 can correspond to a microcontroller having registers having a register context (e.g., a current state of values stored in the registers) such that a register context save operation (e.g., saving register values from the registers of compute block 234 to another memory device that remains powered on) is a low power entry operation when entering a low power state, and a register context restore operation (e.g., reading the register values back from the other memory device to the registers of compute block 234) is a low power exit operation when exiting the low power state. Providing voltage rail 246 while voltage rail 244 is power gated can provide enough power for the microcontroller (e.g., compute block 234) to not require low power entry (and exit) operations, to enable maintaining register values (e.g., the register context) and avoid the latency of the register context save and restore. In other examples, compute block 234 can correspond to or include a memory device that requires save/restore for low power entry/exit. However, compute block 234 can otherwise be idle (e.g., as the other compute blocks of processing component 230 are idle and in a low power state).

In some examples, processing component 230 can correspond to an inference engine such that compute block 234 corresponds to a microprocessor having an SRAM for storing inference weights used by the inference engine. A size of the SRAM needed for the inference weights can require a context save (e.g., saving of the stored values to another memory device that remains powered on) and restore (e.g., reading back the saved values from the other memory device) for low power entry/exit operations that can incur significant latency. By switching compute block 234 to voltage rail 246 when processing component 230 is in a low power state or otherwise power gated, the low power entry/exit operations are not performed and the context save/restore (and respective latency) can be avoided.

In some examples, processing component 230 can correspond to a graphics engine such that compute block 234 corresponds to a memory device of the graphics engine. As described herein, the save/restore latency (e.g., for low power entry/exit) can be avoided by supplying sufficient power (e.g., via voltage rail 246 and power mux 242) to compute block 234 while processing component 230 is in a low power state or otherwise power gated.

When exiting the low power state and power gater 240 restores voltage rail 244 to processing component 230 (e.g. to its compute blocks), control signal 248 can accordingly indicate power mux 242 to switch compute block 234 back to voltage rail 244. Although FIG. 2 illustrates power mux 242 as selecting between voltage rail 244 and voltage rail 246 based on control signal 248, in other examples, power mux 242 can select without control signal 248 (e.g., by selecting a higher voltage rail between its inputs as the output). Moreover, although FIG. 2 illustrates power mux 242 as integrated with processing component 230, in other examples, power mux 242 can be separate from processing component 230. In addition, although FIG. 2 illustrates one compute block 234, in other examples power mux 242 can be coupled to additional iterations of compute block 234. In yet other examples, multiple iterations of power mux 242 can be coupled to different iterations of voltage rail 246 as well as other iterations of compute block 234 to selectively provide voltage rails alternative to voltage rail 244 to certain compute blocks.

For certain power states, power mux 242 can be instructed by the power management circuit (e.g., via control signal 248) to not switch compute block 234 to voltage rail 246. For instance, a deep power state can require power gating processing component 230 without keeping compute block 234 powered on. For the deep power state, compute block 234 can be instructed along with the rest of processing component 230 (e.g., compute block 232A and/or compute block 232B) to enter the deep power state and be power gated along with the rest of processing component 230, and similarly instructed to exit the deep power state along with the rest of processing component 230 when the power gating ends.

FIG. 3 is a flow diagram of an exemplary method 300 for granular power gating override. The steps shown in FIG. 3 can be performed by any suitable circuit, device, and/or system, including the system(s) illustrated in FIGS. 1 and/or 2. In one example, each of the steps shown in FIG. 3 represent an algorithm whose structure includes and/or is represented by multiple sub-steps, examples of which will be provided in greater detail below.

As illustrated in FIG. 3, at step 302 one or more of the systems described herein enter a low power state for a processing component comprising a plurality of compute blocks. For example, processing component 130 can enter a low power state.

The systems described herein can perform step 302 in a variety of ways. In one example, control circuit 112 can initiate, coordinate, facilitate, and/or be notified of processing component 130 entering the low power state, which can include power gating processing component 130 and its sub-components thereof. In some examples, entering the low power state can include low power entry operations for processing component 130 and sub-components thereof (e.g., certain iterations of compute block 132). In some examples, the low power entry operations do not include low power entry operations for certain components (e.g., compute block 132 that remains powered on, as described below).

At step 304 one or more of the systems described herein, in response to entering the low power state, switch a compute block of the plurality of compute blocks from a first voltage rail that is power gated for the low power state to a second voltage rail. For example, control circuit 112 (and/or a power multiplexer) can switch compute block 132 from the first voltage rail (previously powering processing component 130 and its sub-components thereof) to the second voltage rail.

At step 306 one or more of the systems described herein maintain power to the compute block during the low power state. For example, the second voltage rail maintains power to compute block 132 during the low power state of processing component 130.

The systems described herein can perform step 306 in a variety of ways. In one example, control circuit 112 can maintain (e.g., via circuits such as a power multiplexer) power to compute block 132 during the low power state. In some examples, maintaining power to compute block 132 allows compute block 132 to not perform low power entry operations, such as a context save operation for compute block 132 when processing component 130 enters the low power state, as described herein.

In some examples, control circuit 112 can initiate, facilitate, coordinate, and/or be notified of processing component 130 exiting the low power state and in response, switch compute block 132 from the second voltage rail to the first voltage rail. In some examples, exiting the low power state also does not require compute block 132, having remained powered on during the low power state, to perform low power exit operations whereas the rest of processing component 130 can perform low power exit operations.

As detailed above, the systems and methods provided herein introduce a power mux for a microprocessor (MPIPU) of an IPU to retain data such as inference weights, firmware settings, etc. The MPIPU maintains a cache (e.g, a 1 GB SRAM) of the data for the IPU. When the IPU is powered down or put into a deeper power state, the MPIPU and corresponding SRAM is also powered down, losing its stored data. This data can be saved elsewhere and restored when the IPU (and MPIPU) are powered back on. However, this save/restore process incurs significant overhead, in view of the 1 GB size of the SRAM. This overhead can be longer than a time limit for exiting certain power states such that the IPU suffers problems in supporting the lowest power states.

The power mux described herein can connect the normal voltage rail along with a second voltage rail to the MPIPU. The power mux can be controlled by a microcontroller for integration with existing low power entry sequences. When the IPU is power gated (e.g., the normal voltage rail is power gated), the power mux can connect the second voltage rail to the MPIPU to retain the data in its SRAM. The save/restore process can thus be avoided. In addition, the second voltage rail can be lower than the normal voltage rail so as not to unnecessarily burn power to retain the data in SRAM and in some examples the second voltage rail can be selected so as not to significantly exceed the power requirements to support data retention in SRAM. Accordingly, the IPU can support the lowest power states.

As detailed above, the circuits, devices, and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processing component comprising a plurality of compute blocks and configured to operate at a first voltage rail; and
a control circuit configured to, in response to power gating the processing component by power gating the first voltage rail to the processing component, switch at least one of the plurality of compute blocks from the first voltage rail to a second voltage rail.

2. The device of claim 1, wherein the control circuit corresponds to a power multiplexer coupled to the at least one of the plurality of compute blocks and configured to switch the at least one of the plurality of compute blocks between the first voltage rail and the second voltage rail.

3. The device of claim 1, wherein switching the at least one of the plurality of compute blocks from the first voltage rail to the second voltage rail allows the at least one of the plurality of compute blocks to remain powered on while the processing component is power gated.

4. The device of claim 1, wherein power gating the processing component corresponds to entering a low power state.

5. The device of claim 1, wherein the at least one of the plurality of compute blocks corresponds to a microcontroller having one or more registers storing one or more values for a register context and power gating the processing component includes low power entry operations for the plurality of compute blocks.

6. The device of claim 5, wherein switching the at least one of the plurality of compute blocks from the first voltage rail to the second voltage rail provides power to the microcontroller while the processing component is power gated such that the low power entry operations do not include a register context save operation for the microcontroller.

7. The device of claim 1, wherein the processing component corresponds to an inference engine, the at least one of the plurality of compute blocks corresponds to a microprocessor configured to store inference weights, and power gating the processing component includes low power entry operations for the plurality of compute blocks.

8. The device of claim 7, wherein switching the at least one of the plurality of compute blocks from the first voltage rail to the second voltage rail provides power to the microprocessor while the processing component is power gated such that the low power entry operations do not include a context save operation of the inference weights for the microprocessor.

9. The device of claim 1, wherein the at least one of the plurality of compute blocks corresponds to a memory device.

10. The device of claim 9, wherein the processing component corresponds to a graphics engine having the memory device.

11. A system comprising:
a first voltage rail;
a second voltage rail;
a processing component comprising a plurality of compute blocks and configured to operate at the first voltage rail;
a power gater configured to couple the first voltage rail to the processing component;
a power multiplexer coupled between the power gater and a compute block of the plurality of compute blocks and configured to switch the compute block between the first voltage rail and the second voltage rail; and
a control circuit configured to, in response to power gating the processing component by power gating the first voltage rail to the processing component, switch the compute block from the first voltage rail to the second voltage rail using the power multiplexer.

12. The system of claim 11, wherein the second voltage rail remains on during low power states of the system.

13. The system of claim 11, wherein power gating the processing component corresponds to entering a low power state and switching the compute block from the first voltage rail to the second voltage rail allows the compute block to remain powered on during the low power state.

14. The system of claim 13, wherein:
the compute block corresponds to a microcontroller having a register storing a value for a register context;
entering the low power state includes low power entry operations for the plurality of compute blocks; and
switching the compute block from the first voltage rail to the second voltage rail provides power to the microcontroller during the low power state such that the low power entry operations do not include a register context save operation for the microcontroller.

15. The system of claim 13, wherein:
the processing component corresponds to an inference engine and the compute block corresponds to a microprocessor configured to store inference weights;
entering the low power state includes low power entry operations for the plurality of compute blocks; and
switching the compute block from the first voltage rail to the second voltage rail provides power to the microprocessor during the low power state such that the low power entry operations do not include a context save operation of the inference weights for the microprocessor.

16. The system of claim 11, wherein the at least one of the plurality of compute blocks corresponds to a memory device.

17. The system of claim 16, wherein the processing component corresponds to a graphics engine having the memory device.

18. A method comprising:
entering a low power state for a processing component comprising a plurality of compute blocks;
in response to entering the low power state, switching a compute block of the plurality of compute blocks from a first voltage rail that is power gated for the low power state to a second voltage rail; and
maintaining power to the compute block during the low power state.

19. The method of claim 18, wherein entering the low power state includes low power entry operations for the plurality of compute blocks, and the low power entry operations do not include low power entry operations for the compute block.

20. The method of claim 18, further comprising:
exiting the low power state for the processing component; and
in response to exiting the low power state, switching the compute block from the second voltage rail to the first voltage rail.
